(19) United States
(12) Patent Application Publication
(10) Pub. No.: US 2008/0026206 A1
(43) Pub. Date: Jan. 31, 2008

(54) Touch panel

(76) Inventors: Kenichi Matsumoto, Osaka (JP); Yasutaka Yamamoto, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/785,696

(22) Filed: Apr. 19, 2007

(30) Foreign Application Priority Data
Jul. 25, 2006 (JP) 2006-201567

(51) Int. Cl. B32B 5/16

(52) U.S. Cl. 428/327

(57) ABSTRACT

The invention presents a touch panel easy in peeling off and adhering to a display element. The touch panel of the invention forms a strong adhesive layer and a weak adhesive layer overlaid on the downside of a lower substrate. When peeling and adhering again the touch panel, it can be easily peeled off, and the weak adhesive layer does not transfer and stick to the display element.

### FIELD OF THE INVENTION

The invention relates to a touch panel used mainly in manipulation of various electronic appliances.

### BACKGROUND OF THE INVENTION

Recently, mobile telephones, car navigation systems, and various electronic appliances are much more diversified and advanced in function. In this trend, a light transmitting touch panel is provided at the front side of a display element such as liquid crystal, and the character, symbol or pattern shown in the backside display element is visually recognized or selected through the touch panel, and the touch panel is pressed by finger, pen or the like. In this manner, functions of the apparatus are changed over, and a touch panel advanced in visual recognition and ease of operation is demanded.

Such conventional touch panel is explained by referring to FIG. 3 and FIG. 4.

For the ease of understanding of the structure, in FIG. 3 and FIG. 4, the dimension in the thickness direction is shown in a magnified view.

FIG. 3 is a sectional view of a conventional touch panel. In FIG. 3, a touch panel 9 comprises an upper substrate 1, a lower substrate 2, an upper conductive layer 3, a lower conductive layer 4, a spacer 5, an adhesive layer 6, and a parting paper 7.

The upper substrate 1 is a film and is light transmittable. The lower substrate 2 is similarly light transmittable. The upper conductive layer 3 of light transmitting indium tin oxide or similar material is formed on the downside of the upper substrate 1, and the lower conductive layer 4 is similarly formed on the upside of the lower substrate 2.

On the upside of the lower conductive layer 4, a plurality of dot spacers (not shown) are formed of insulating resin at specified intervals. At the same time, a pair of upper electrodes (not shown) are formed at both ends of the upper conductive layer 3. At both ends of the lower conductive layer 4, a pair of lower electrodes (not shown) are formed in an orthogonal direction of the upper electrode.

The spacer 5 is formed like a picture frame around the downside of upper conductive layer 3 or the upside of lower conductive layer 4. An adhesive layer (not shown) is applied and formed on the upside or downside of this spacer 5. By this adhesive layer (not shown), the outer circumferences of the upper conductive layer 3 and lower conductive layer 4 are adhered, and the upper conductive layer 3 and lower conductive layer 4 are opposite to each other across a specified interval.

The adhesive layer 6 is made of acrylic or silicone rubber, and is formed at the downside of the lower substrate 2. The parting paper 7 is adhered to the downside of the adhesive layer 6, and the touch panel 9 is constituted.

The touch panel 9 having such configuration is stripped of the parting paper 7, and is adhered to the front side of a display element 10 such as liquid crystal by the downside of the adhesive layer 6 as shown in a sectional view in FIG. 4. At the same time, a pair of upper electrode and lower electrode are connected to an electronic circuit (not shown) of an appliance, and installed in the electronic appliance.

In this configuration, the user presses and operates the upside of the upper substrate 1 by a finger or a pen, while visually recognizing the display of the display element 10 on the backside of the touch panel 9. By pressing operation, the upper substrate 1 is flexed, and the upper conductive layer 3 at the pressed position contacts with the lower conductive layer 4.

Consequently, a voltage is applied sequentially from the electronic circuit to the upper electrode and lower electrode. By voltage difference between these electrodes, the pressed position is detected by the electronic circuit, and various functions of the appliance are changed over.

When adhering the touch panel 9 to the front side of the display element 10, meanwhile, the gluing position may be deviated. In the event of deviation, if attempted to adhere again by peeling off once, the following problems may occur. That is, when an acrylic or other strong adhesive material is used as the adhesive layer 6, since the adhesion of the adhesive layer 6 is strong, the adhesive layer 6 may be torn irregularly, remaining pieces of the adhesive layer 6 may be left over on the downside of lower substrate 2 and the upside of display element 10.

Therefore, the sticking pieces of the adhesive 6 must be removed from the upside of the display element 10, and a new touch panel 9 must be adhered to the display element 10. It takes extra time and labor for adhering again.

When silicone rubber or other weak adhesive material is used as adhesive layer 6, the adhesion of the adhesive layer 6 is weak, and the entire adhesive layer 6 is transferred and stuck to either the downside of lower substrate 2 or the upside of display element 10. As a result, when the adhesive layer 6 is left over on the upside of the display element 10, it must be removed when adhering again.

A technology related to the invention of the present application is disclosed, for example, in the publication of Japanese Patent Application Laid-Open No. 2005-274667.

### SUMMARY OF THE INVENTION

A touch panel comprises:

a light transmitting upper substrate having an upper conductive layer formed at the downside,

a light transmitting lower substrate having a lower conductive layer formed at the upside, being opposite to the upper conductive layer across a specified interval,

a strong adhesive layer, and

a weak adhesive layer,

in which the strong adhesive layer and weak adhesive layer are overlaid and formed on the downside of the lower substrate.

### BRIEF DESCRIPTION OF THE DRAWINGS

FIG. 1 is a sectional view of touch panel in an preferred embodiment of the invention.

FIG. 2 is a sectional view of input device using the touch panel in the preferred embodiment of the invention.

FIG. 3 is a sectional view of touch panel in a prior art.

FIG. 4 is a sectional view of input device using the touch panel in the prior art.

### DETAILED DESCRIPTION OF THE EXEMPLARY EMBODIMENTS

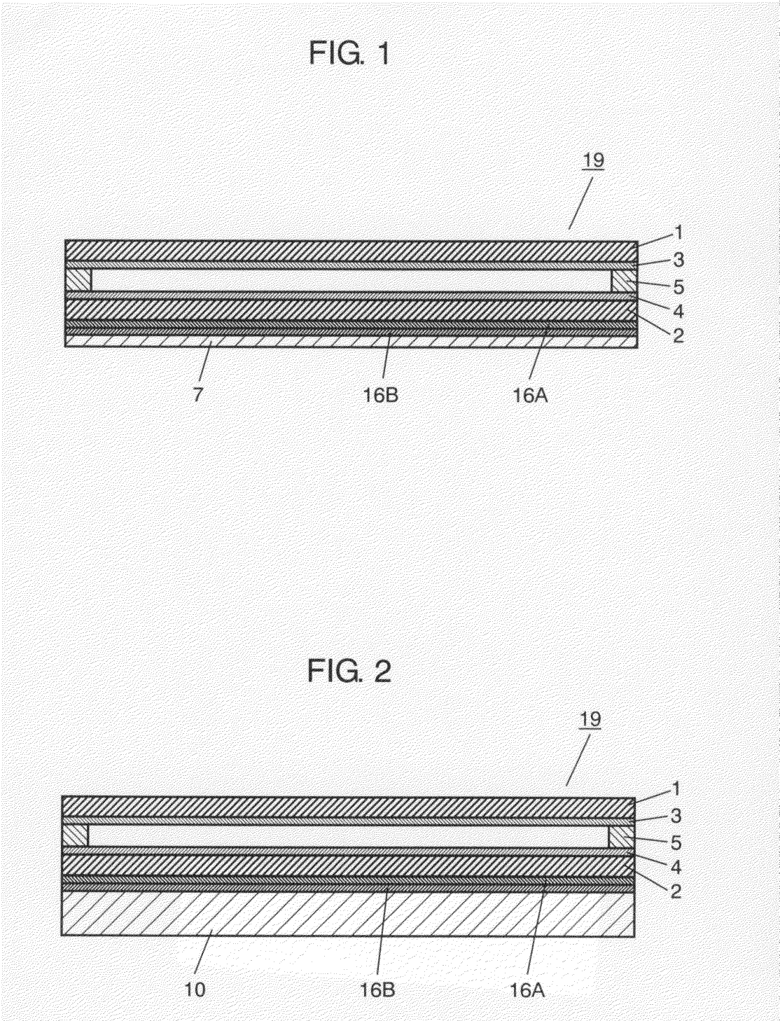

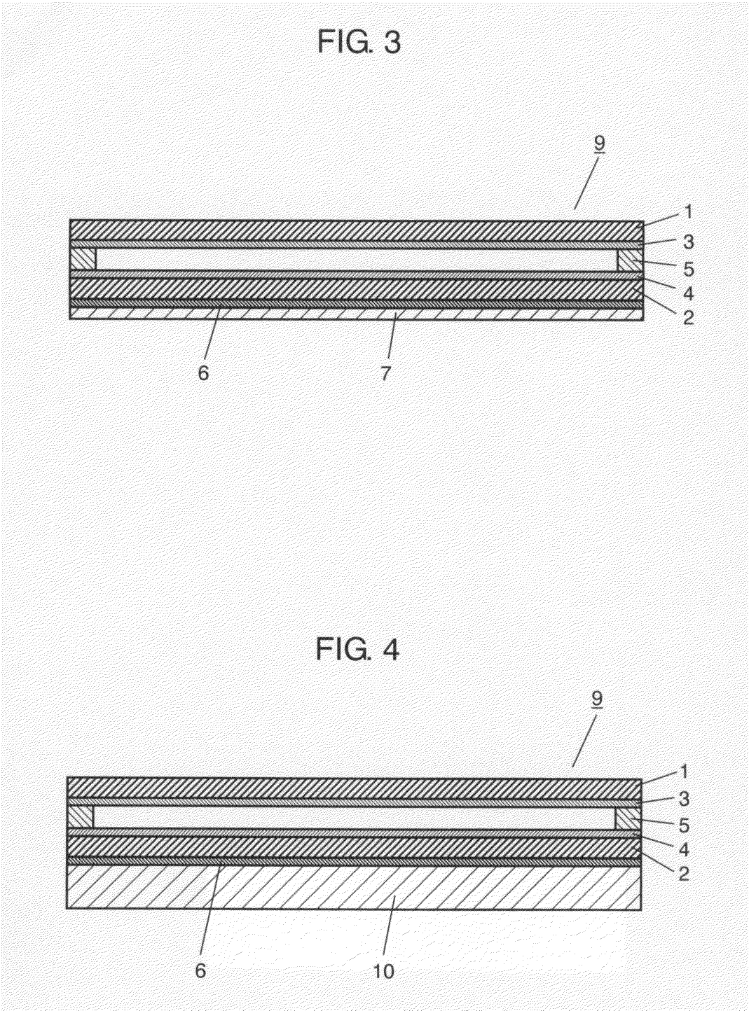

An preferred embodiment of the invention is described below while referring to FIG. 1 and FIG. 2.

For the ease of understanding of the structure, in FIG. 1 and FIG. 2, the dimension in the thickness direction is shown in a magnified view.

Same parts as in explained in the background art are identified with same reference numerals, and duplicate explanation is omitted.

### Preferred Embodiment

FIG. 1 is a sectional view of touch panel in an preferred embodiment of the invention. In FIG. 1, a touch panel 19 comprises an upper substrate 1, a lower substrate 2, an upper conductive layer 3, a lower conductive layer 4, a spacer 5, a parting paper 7, a strong adhesive layer 16A, and a weak adhesive layer 16B.

The upper substrate 1 is a film formed of polyethylene terephthalate, polycarbonate, or polyether sulfone, and is light transmittable. The lower substrate 2 is formed of glass, acrylic or polycarbonate, and is light transmittable. The upper conductive layer 3 is formed of indium tin oxide or tin oxide on the downside of the upper substrate 1, and is light transmittable. The lower conductive layer 4 is formed on the upside of the lower substrate 2 by sputtering or other method.

On the upside of the lower conductive layer 4, a plurality of dot spacers (not shown) are formed of insulating resin such as epoxy or silicone at specified intervals. At the same time, a pair of upper electrodes (not shown) of silver or carbon are formed at both ends of the upper conductive layer 3. At both ends of the lower conductive layer 4, a pair of lower electrodes (not shown) are formed in an orthogonal direction of the upper electrode.

The spacer 5 is formed of epoxy or polyester like a picture frame around the downside of upper conductive layer 3 or the upside of lower conductive layer 4. An adhesive layer (not shown) is applied and formed on the upside or downside of this spacer 5. This adhesive layer is made of acrylic rubber or rubber. By this adhesive layer, the outer circumferences of the upper conductive layer 3 and lower conductive layer 4 are adhered, and the upper conductive layer 3 and lower conductive layer 4 are opposite to each other across a specified interval.

The strong adhesive layer 16A is made of an acrylic material, and its adhesion to glass is 0.1 to 20 N/cm. The weak adhesive layer 16B is made of an olefin or styrene material, and its adhesion to glass is 0.01 to 0.5 N/cm. The strong adhesive layer 16A and weak adhesive layer 16B are overlaid and formed on the downside of the lower substrate 2.

The parting paper 7 such as paper or film is adhered to the downside of the weak adhesive layer 16B, and the parting paper 7 covers the downside of the weak adhesive layer 16B, and the touch panel 19 is constituted.

The strong adhesive layer 16A and weak adhesive layer 16B are manufactured in the following procedure. The strong adhesive layer 16A is first applied and dried by screen printing on the downside of the lower substrate 2 having the lower conductive layer 4 and lower electrode formed on the upside. On the strong adhesive layer 16A, the weak adhesive layer 16B is overlaid and formed, and the strong adhesive layer 16A and weak adhesive layer 16B can be manufactured easily.

The touch panel 19 having such configuration is stripped of the parting paper 7, and is adhered to the front side of a display element 10 such as liquid crystal by way of the weak adhesive layer 16B as shown in a sectional view in FIG. 2. At the same time, a pair of upper electrode and lower electrode are connected to an electronic circuit (not shown) of an appliance, and installed in the electronic appliance.

In this configuration, the user presses and operates the upside of the upper substrate 1 by a finger or a pen, while visually recognizing the display of the display element 10 on the backside of the touch panel 19. By pressing operation on the touch panel 19, the upper substrate 1 is flexed, and the upper conductive layer 3 at the pressed position contacts with the lower conductive layer 4.

Consequently, a voltage is applied sequentially from the electronic circuit to the upper electrode and lower electrode, and on the basis of the voltage difference between these electrodes, the pressed position is detected by the electronic circuit, and various functions of the appliance are changed over on the basis of the result of detection.

The touch panel 19 is adhered to the front side of the display element 10 by the weak adhesive layer 16B overlaid and formed on the strong adhesive layer 16A at the downside of the lower substrate 2. Accordingly, when adhering the touch panel 19 to the display element 10, if the gluing position is deviated, it may be easily peeled off and adhered correctly again easily.

That is, when peeling off the touch panel 19 from the display element 10, adhesion of display element 10 and touch panel 19 depends only on the weak adhesive layer 16B of weak adhesion. Hence, the touch panel 19 can be easily separated from the display element 10 by a light effort.

This weak adhesive layer 16B is adhered to the strong adhesive layer 16A of strong adhesion. When peeling off the touch panel 19, it is peeled off while the entire weak adhesive layer 16B is adhered to the strong adhesive layer 16A. As a result, the weak adhesive layer 16B is not transferred to stick to the upside of the display element 10, and time and labor for removing it can be saved.

Further, since the weak adhesive layer 16B is formed of a thermoplastic elastomer such as olefin or styrene, the adhesive force of the weak adhesive layer 16B can be adjusted easily by the blending ratio of the materials.

That is, the invention is realized if a single material of silicone rubber or urethane rubber is used as the weak adhesive layer 16B. However, in the case of thermoplastic elastomer, soft segment and hard segment are mixed. Examples of olefin system thermoplastic elastomer include ethylene-propylene and polyethylene-polypropylene. Examples of styrene system thermoplastic elastomer include polybutadiene and polystyrene. Examples of urethane system thermoplastic elastomer include polyester-polyether and polyurethane. Examples of ester system thermoplastic elastomer include polyether-polyester and polyester. Examples of polyvinyl chloride system thermoplastic elastomer include noncrystalline and crystalline polyvinyl chloride.

Therefore, when a thermoplastic elastomer is used in the weak adhesive layer 16B, the adhesion may be easily changed by the blending ratio of these materials. Hence, the adhesion of the weak adhesive layer 16B can be adjusted depending on the adhesion of the strong adhesive layer 16A, so that a desired peeling force may be obtained.

Thus, in the preferred embodiment, the strong adhesive layer 16A and weak adhesive layer 16B are overlaid and formed on the downside of the lower substrate 2. Thus, when the touch panel 19 once adhered to the upside of the display element 10 is peeled off and glued again, it can be easily separated from the display element 10. At the same time, the weak adhesive layer 16B is not transferred to stick to the upside of the display element 10, and time and labor for removing it can be saved, so that a touch panel that can be easily adhered again can be obtained.

In the preferred embodiment, the weak adhesive layer 16B is formed of thermoplastic elastomer. Hence, as compared with a weak adhesive layer formed of a single material of silicone rubber or urethane rubber, the adhesion of the weak adhesive layer 16B can be adjusted easily by the blending ratio of materials.

As clear from the description herein, the invention presents a touch panel that can be easily peeled off and adhered again to the display element. The touch panel of the invention has such advantages, and it is very useful for operation of various electronic appliances.

What is claimed is:

1. A touch panel comprising:
a light transmitting upper substrate having an upper conductive layer formed at the downside;
a light transmitting lower substrate having a lower conductive layer formed at the upside, being opposite to the upper conductive layer across a specified interval;
a strong adhesive layer; and
a weak adhesive layer,
wherein the strong adhesive layer and weak adhesive layer are overlaid and formed on the downside of the lower substrate.

2. The touch panel of claim 1, wherein the weak adhesive layer is formed of a thermoplastic elastomer.
